(19) United States
(12) Patent Application Publication
(10) Pub. No.: US 2009/0160784 A1
(43) Pub. Date: Jun. 25, 2009

(54) COMPUTER AND SWITCHING CIRCUIT

(75) Inventor: Masaaki ISHIDA, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/963,037

(22) Filed: Dec. 21, 2007

(30) Foreign Application Priority Data
Dec. 19, 2007 (JP) 2007-326681

(51) Int. Cl. G06F 3/041

(52) U.S. Cl. 345/173

(57) ABSTRACT

A RF module generates a high-frequency transmission signal. An inclination sensor detects an inclination of a computer to detect that an antenna is set in a state where the antenna may come close to a user's body. A mode sensor detects that a first housing unit is closed by facing other main plane of a first housing unit and one main plane of the second housing unit. A control circuit generates a switching signal when a detection signal is not less than a predetermined level, in a case where the mode sensor detects that the first housing unit is closed by facing other main plane of the first housing unit and one main plane of the second housing unit, and concurrently where the antenna is set in the state where the antenna may come close to a user's body. A switching circuit outputs, to the antenna, the high-frequency transmission signal after relatively attenuating the high-frequency transmission signal in comparison with the high-frequency transmission signal in the case where the switching signal is not inputted, in a case where the switching signal is inputted to the switching circuit from the control circuit.

### BACKGROUND OF THE INVENTION

1. Field of the Invention

The present invention relates to an antenna module and a switching circuit, both incorporated in a device that performs radio communications. In particular, the present invention relates to a technique for operating a device at or below a maximum acceptable SAR (Specific Absorption Rate) level.

Suppose the case of using a convertible type tablet personal computer (hereinafter, referred to simply as a “computer”) set in a tablet mode in which the LCD (Liquid Crystal Display) is folded back to overlap the main body. In this case, the computer may be used in a landscape position as shown in FIG. 1A, or in a portrait position as shown in FIG. 1B.

A Tx antenna of the computer is provided in, for example, part of a frame of the LCD. When the computer is used in the portrait position as shown in FIG. 1B, the Tx antenna is brought close to the body. When the computer is to be used in this state, the computer relatively comes close to a maximum acceptable SAR level defined in the standards of the FCC (the Federal Communications Commission).

In this respect, a computer incorporating a conventional antenna module of the third generation (3G) is configured as follows. Specifically, the angle of a hinge provided between a LCD and a main body, as well as the inclination of a display surface of the LCD, are detected. Then, from the detected angle and inclination, it is detected whether or not the Tx antenna is set in a state where the Tx antenna may come close to the body. Upon detection that the Tx antenna is set in the above state, the computer stops the radiation of radio waves from the Tx antenna.

For the purpose of suppressing the SAR at or below the maximum acceptable level in such an antenna module, a high-frequency transmission signal may be attenuated before being radiated as a radio wave from the Tx antenna. As a technique to attenuate a high-frequency transmission signal, there is a known antenna switch disclosed Japanese Patent Application Unexamined Publication No. Hei 9-200074. When contiguous communications are performed between two wireless devices, the speech quality may be deteriorated due to an excessive input. This antenna switch prevents such deterioration of the speech quality without deteriorating the receiver noise figure.

This antenna switch includes a single pole/double throw (SPDT) electrical switch, two single pole/single throw (SPST) electrical switches, and an attenuator, all of which are integrated on a single chip. In addition, one of the SPST electrical switches, the attenuator, and the other one of the SPST electrical switches, are connected sequentially in this order between the single pole terminal and one of the throw terminals of the SPDT electrical switch.

However, as described above, when the conventional computer is used in the tablet mode as well as in the vertical position as shown in FIG. 1B, the computer relatively comes close to the maximum acceptable SAR level. For this reason, since the 3G antenna module cannot be used, the communication function of the computer cannot be used.

### SUMMARY OF THE INVENTION

An object of the present invention is to provide a computer and a switching circuit, each being capable of continuing to operate without stopping its communication function while being kept at or below the maximum acceptable SAR level.

A first aspect of the present invention provides a computer. The computer includes a first housing unit, a second housing unit, a hinge unit, a mode sensor, an antenna, a RF module, an inclination sensor, a control circuit, and a switching circuit. The first housing unit includes a display unit which displays a image and a tablet unit which is superposed to the display unit to transmit the image. The second housing unit includes an arithmetic circuit which generates a signal for controlling to display the image. The hinge unit causes the first housing unit to be connected to the second housing unit so that the first housing unit is closed by facing one main plane which the first housing unit forms to crop out the tablet unit and other main plane which the second housing unit forms, and is connected to the second housing unit so that the first housing unit is closed by facing other main plane which the first housing unit forms and the one main plane which the second housing unit forms. The mode sensor detects that the first housing unit is closed by facing the other main plane of the first housing unit and the one main plane of the second housing unit. The antenna converts a high-frequency transmission signal into a radio wave, and which then radiates the radio wave. The RF module generates the high-frequency transmission signal. The inclination sensor detects an inclination of the computer so as to detect that the antenna is set in a state where the antenna may come close to a user's body. The control circuit generates a switching signal when a level of the high-frequency transmission signal sent from the RF module is not less than a predetermined level, in a case where the mode sensor detects that the first housing unit is closed by facing the other main plane of the first housing unit and the one main plane of the second housing unit, and concurrently where the inclination sensor detects that the antenna is set in the state where the antenna may come close to the user's body. The switching circuit outputs, to the antenna, the high-frequency transmission signal sent from the RF module, in a case where the switching signal is not inputted to the switching circuit from the control circuit, and outputs, to the antenna, the high-frequency transmission signal sent from the RF module after relatively attenuating the high-frequency transmission signal in comparison with the high-frequency transmission signal in the case where the switching signal is not inputted, in a case where the switching signal is inputted to the switching circuit from the control circuit.

A second aspect of the present invention provides a computer. The computer includes a first housing unit, a second housing unit, a hinge unit, a mode sensor, an antenna, a RF module, an inclination sensor, a control circuit, and an attenuation circuit. The first housing unit includes a display unit which displays a image and a tablet unit which is superposed to the display unit to transmit the image. The second housing unit includes an arithmetic circuit which generates a signal for controlling to display the image. The hinge unit causes the first housing unit to be connected to the second housing unit so that the first housing unit is closed by facing one main plane which the first housing unit forms to crop out the tablet unit and other main plane which the second housing unit forms, and is connected to the second housing unit so that the first housing unit is closed by facing other main plane which the first housing unit forms and the one main plane which the second housing unit forms. The mode sensor detects that the first housing unit is closed by facing the other main plane of the first housing unit and the one main plane of the second housing unit. The antenna converts a high-frequency transmission signal into a radio wave, and which then radiates the radio wave. The RF module generates the high-frequency transmission signal. The inclination sensor detects an inclination of the computer so as to detect that the antenna is set in a state where the antenna may come close to a user's body. The control circuit generates a control signal for attenuating the high-frequency transmission signal sent from the RF module to a level immediately below a maximum acceptable level based on the high-frequency transmission signal sent from the RF module, in a case where the mode sensor detects that the first housing unit is closed by facing the other main plane of the first housing unit and the one main plane of the second housing unit, and concurrently where the inclination sensor detects that the antenna is set in the state where the antenna may come close to the user's body. The attenuation circuit outputs, to the antenna, the high-frequency transmission signal sent from the RF module after attenuating the high-frequency transmission signal by an amount corresponding to the control signal sent from the control circuit.

A third aspect of the present invention provides a computer. The computer includes a first housing unit, a second housing unit, a hinge unit, a mode sensor, an antenna, a RF module, a reception-level determination circuit, an inclination sensor, a control circuit, and a switching circuit. The first housing unit includes a display unit which displays a image and a tablet unit which is superposed to the display unit to transmit the image. The second housing unit includes an arithmetic circuit which generates a signal for controlling to display the image. The hinge unit causes the first housing unit to be connected to the second housing unit so that the first housing unit is closed by facing one main plane which the first housing unit forms to crop out the tablet unit and other main plane which the second housing unit forms, and is connected to the second housing unit so that the first housing unit is closed by facing other main plane which the first housing unit forms and the one main plane which the second housing unit forms. The mode sensor detects that the first housing unit is closed by facing the other main plane of the first housing unit and the one main plane of the second housing unit. The antenna generates a high-frequency reception signal upon reception of an incoming radio wave, and which also converts a high-frequency transmission signal into a radio wave so as to radiate the radio wave. The RF module generates the high-frequency transmission signal to be sent to the antenna, and which also generates a reception signal from the high-frequency transmission signal sent from the antenna. The reception-level determination circuit determines a level of the reception signal sent from the RF module. The inclination sensor detects an inclination of the computer so as to detect that the antenna is set in a state where the antenna may come close to a user's body. The control circuit generates a switching signal when the level of the reception signal is not more than a predetermined level, in a case where the mode sensor detects that the first housing unit is closed by facing the other main plane of the first housing unit and the one main plane of the second housing unit, and concurrently where the inclination sensor detects that the antenna is set in the state where the antenna may come close to the user's body. The switching circuit outputs, to the antenna, the high-frequency transmission signal sent from the RF module, in a case where the switching signal is not inputted to the switching circuit from the control circuit, and outputs, to the antenna, the high-frequency transmission signal sent from the RF module after relatively attenuating the high-frequency transmission signal in comparison with the high-frequency transmission signal in the case where the switching signal is not inputted, in a case where the switching signal is inputted to the switching circuit from the control circuit.

According to the present invention, a computer incorporating the antenna module can continue to operate without stopping its communication function while being kept at or below the maximum acceptable SAR level.

### BRIEF DESCRIPTION OF THE DRAWINGS

FIG. 1A is a diagram for explaining a state where a conventional computer is used in a landscape position, while FIG. 1B is a diagram for explaining a state where the conventional computer is used in a portrait position.

FIG. 2 shows the configuration of a convertible type computer incorporating an antenna module according to Embodiment 1 of the present invention.

FIG. 3 is a circuit diagram showing, in an extracted manner, an antenna module part of the convertible type computer incorporating the antenna module according to Embodiment 1 of the present invention.

FIG. 4 specifically shows a circuit configuration for an ATT switching circuit used in the antenna module according to Embodiment 1 of the present invention.

FIG. 5 specifically shows another circuit configuration for the ATT switching circuit used in the antenna module according to Embodiment 1 of the present invention.

FIG. 6 is a circuit diagram showing, in an extracted manner, an antenna module part of a convertible type computer incorporating an antenna module according to Embodiment 2 of the present invention.

FIG. 7 is a circuit diagram showing, in an extracted manner, an antenna module part of a convertible type computer incorporating an antenna module according to Embodiment 3 of the present invention.

### DESCRIPTION OF THE PREFERRED EMBODIMENTS

Hereinafter, embodiments of the present invention will be described in detail with reference to the drawings.

### Embodiment 1

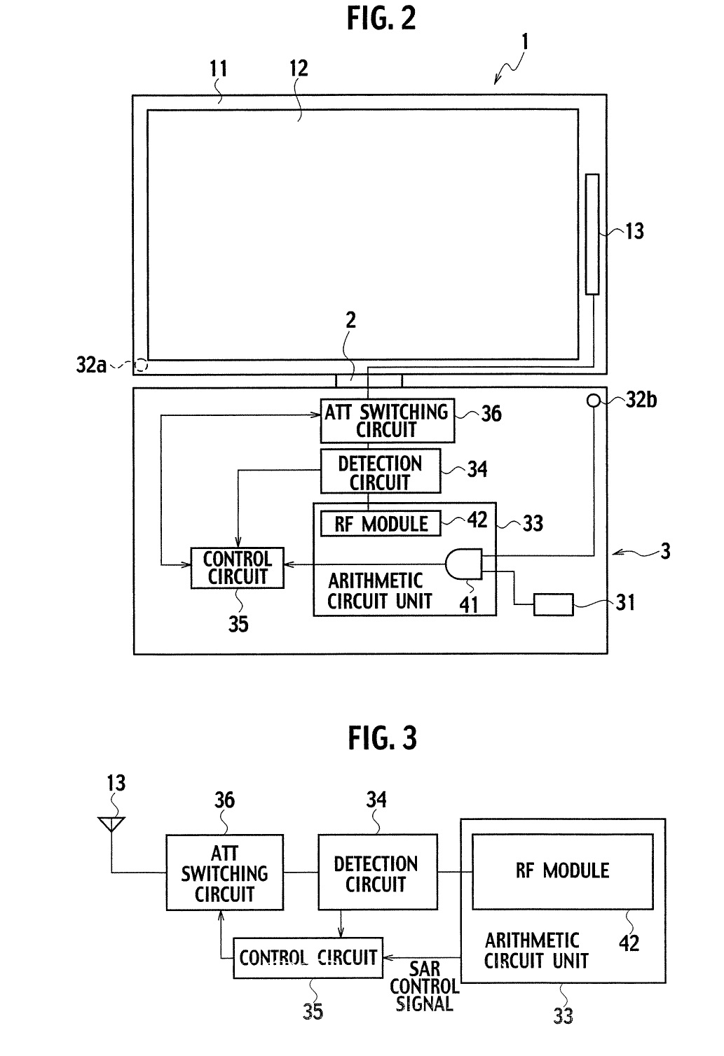

FIG. 2 shows the configuration of a convertible type computer incorporating an antenna module according to Embodiment 1 of the present invention. FIG. 3 is a circuit diagram showing an antenna module part of the computer in an extracted manner.

As shown in FIG. 2, the computer includes a lid unit 1 and a main body unit 3 to which the lid unit 1 is attached with a rotating hinge 2 provided in between. The lid unit 1 includes a LCD 12 and an antenna 13. The LCD 12 is fixed to a frame 11, while the antenna 13 is provided in part of the frame 11. The LCD 12 displays various kinds of information sent from the main body unit 3, and also transmits, to the main body unit 3, information indicating the position designated by using a tablet (not shown).

The antenna 13 converts, into a radio wave, a high-frequency transmission signal sent thereto through a wire extending from the main body unit 3 via the rotating hinge 2 to the antenna 13. The antenna 13 then radiates the radio wave thus obtained.

The main body unit 3 includes an inclination sensor 31, a tablet-mode sensor 32, an arithmetic circuit unit 33, a detection circuit 34, a control circuit 35, and an ATT (attenuator) switching circuit 36. Note that, although not illustrated, on the main body unit 3, mounted are a keyboard, a disk drive, a pad, various switches, various indicators, and the like.

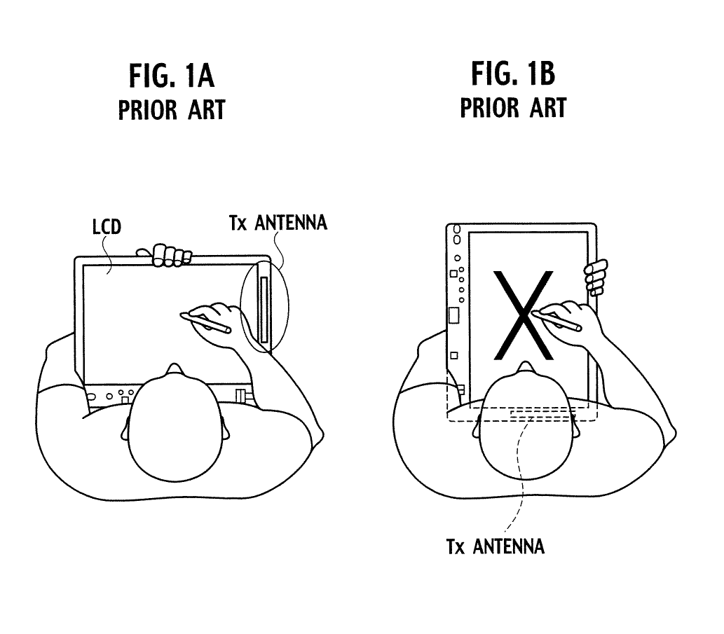

The inclination sensor 31 detects the inclination of the computer, thereby detecting that the antenna 13 is set in a state where the antenna 13 may come closer to the body of the user. In this embodiment, the inclination sensor 31 detects whether the computer is set in a landscape position as shown in FIG. 1A, or in a portrait position as shown in FIG. 1B. When the inclination sensor 31 detects that the computer is set in a portrait position, that is, when the antenna 13 is set in a state where the antenna is to be brought closer to the body, a portrait-position signal indicating this event is sent from the inclination sensor 31 to the arithmetic circuit unit 33.

The tablet-mode sensor 32 is constituted of, for example, a protrusion 32a and a micro switch 32b. The protrusion 32a is provided to a surface (a surface different from that having the LCD 12 mounted therein) of the lid unit 1, while the micro switch 32b is attached to a surface (a surface having the keyboard and the like mounted therein) of the main body unit 3. When the surface of the lid unit 1 is brought into contact with the surface of the main body unit 3 by rotating the lid unit 1 by 180 degrees about the rotating hinge 2, the computer is set in a tablet mode. At this time, the micro switch 32b is pressed down by the protrusion 32a, thus transmitting, to the arithmetic circuit unit 33, a tablet-mode signal which indicates that the computer is set in the tablet mode.

Note that, the tablet-mode sensor 32 may alternatively be configured of a magnet and a magnet sensor. Specifically, the magnet is disposed in the surface of the lid unit 1 instead of the protrusion 32a, while the magnet sensor is attached to the main body unit 3 instead of the micro switch 32b. In this case, when the surface of the lid unit 1 is brought into contact with the surface of the main body unit 3 by rotating the lid unit 1 by 180 degrees about the rotating hinge 2, the magnet sensor is brought to face the magnet, thus transmitting a tablet-mode signal to the arithmetic circuit unit 33.

The arithmetic circuit unit 33 controls entirely the computer. The arithmetic circuit unit 33 includes an AND circuit 41 and a RF module 42. It should be noted that the arithmetic circuit unit 33 incorporates unillustrated various control circuits for controlling the computer in addition to the AND circuit 41 and the RF module 42.

The AND circuit 41 performs a logical AND operation on the portrait-position signal sent from the inclination sensor 31 and the tablet-mode signal sent from the micro switch 32b. The AND circuit 41 then sends the resultant signal of the logical AND operation as a SAR control signal to the control circuit 35.

The RF module 42 generates a high-frequency transmission signal based on a transmission signal generated inside the arithmetic circuit unit 33. The RF module 42 then transmits the generated high-frequency transmission signal to the detection circuit 34.

The detection circuit 34 detects a high-frequency transmission signal sent from the RF module 42 of the arithmetic circuit unit 33. The detection circuit 34 then transmits the result of the detection as a detection signal to the control circuit 35, and concurrently transmits the high-frequency transmission signal to the ATT switching circuit 36.

Suppose a case where a SAR control signal sent from the AND circuit 41 of the arithmetic circuit unit 33 is active, that is, a case where the computer is set in the tablet mode as well as in the portrait position. In this case, the control circuit 35 compares the level of the detection signal sent from the detection circuit 34 with a predetermined level (a level with which a radio wave exceeds a maximum acceptable SAR level when the antenna 13 radiates the radio wave upon receipt of a corresponding high-frequency transmission signal sent from the detection circuit 34). When the level of the detection signal is not less than the predetermined level, the control circuit 35 generates a switching signal, and then transmits the generated signal to the ATT switching circuit 36.

When the switching signal is not inputted to the ATT switching circuit 36 from the control circuit 35, the ATT switching circuit 36 allows the high-frequency transmission signal sent from the detection circuit 34 to pass through the ATT switching circuit 36 without being intentionally attenuated, and then outputs the signal to the antenna 13. On the other hand, when the switching signal is inputted from the control circuit 35, the ATT switching circuit 36 attenuates the high-frequency transmission signal sent from the detection circuit 34 by a predetermined amount, and then outputs the attenuated signal to the antenna 13.

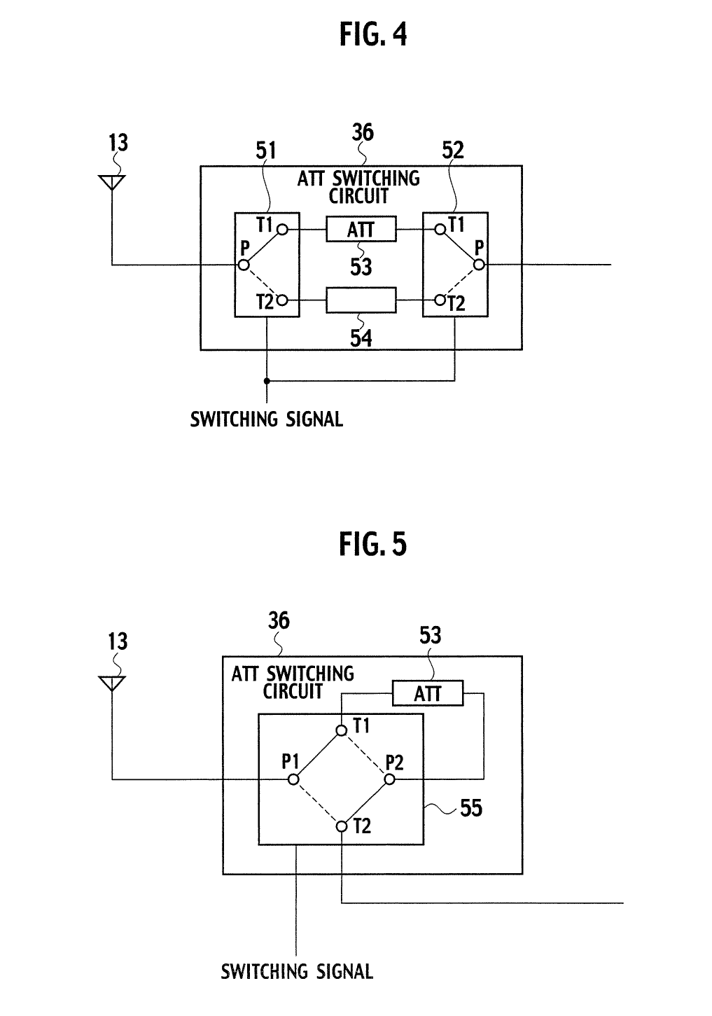

FIG. 4 shows a conventionally-used circuit configuration for the ATT switching circuit 36. This ATT switching circuit 36 is constituted of a first SPDT (Single Pole/Double Throw) switch 51, a second SPDT switch 52, an attenuator (ATT) 53, and a through pattern 54. A pole P, a first contact terminal T1, and a second contact terminal T2, of the first SPDT switch 51 are connected respectively to the antenna 13, a first end of the attenuator 53, and a first end of the through pattern 54. In the same manner, a pole P, a first contact terminal T1, and a second contact terminal T2, of the second SPDT switch 52 are connected respectively to the detection circuit 34 (not shown), a second end of the attenuator 53, and a second end of the through pattern 54.

In a state where a switching signal is not inputted from the control circuit 35 to the ATT switching circuit 36 with the above-described configuration, a high-frequency transmission signal sent from the detection circuit 34 needs to be allowed to pass through the ATT switching circuit 36 without being intentionally attenuated. Accordingly, the pole P of the first SPDT switch 51 is connected to the second contact terminal T2 thereof, while the pole P of the second SPDT switch 52 is connected to the second contact terminal T2 thereof.

As a result, a high-frequency transmission signal sent from the detection circuit 34 is sent to the antenna 13 after passing sequentially through: the pole P, and the second contact terminal T2, in the second SPDT switch 52; the through pattern 54; and then the second contact terminal T2, and the pole P, in the first SPDT switch 51. In this case, attenuation in the ATT switching circuit 36 occurs in the second SPDT switch 52, the through pattern 54, and the first SPDT switch 51. Accordingly, the high-frequency transmission signal sent from the detection circuit 34 is attenuated by only a certain minute amount to be sent to the antenna 13.

On the other hand, in a state where a switching signal is inputted to the ATT switching circuit 36 from the control circuit 35, the pole P of the first SPDT switch 51 is connected to the first contact terminal T1 thereof, while the pole P of the second SPDT switch 52 is connected to the first contact terminal T1 thereof.

As a result, a high-frequency transmission signal sent from the detection circuit 34 is sent to the antenna 13 after passing sequentially through: the pole P, and the first contact terminal T1, of the second SPDT switch 52; the attenuator 53; and then the first contact terminal T1, and the pole P, of the first SPDT switch 51. In this case, the amount of attenuation in the ATT switching circuit 36 depends largely on the attenuator 53, which has an amount of attenuation significantly larger than the amount of attenuation occurring in the first and second SPDT switches 51 and 52. Accordingly, the high-frequency transmission signal sent from the detection circuit 34 is attenuated by a predetermined amount (for example, by 10 db) to be sent to the antenna 13.

FIG. 5 shows a new circuit configuration for the ATT switching circuit 36. This ATT switching circuit 36 is constituted of an attenuator (ATT) 53 and a DPDT (Double Pole/Double Throw) switch 55. A first pole P1, and a second pole P2, of the DPDT switch 55 are connected respectively to the antenna 13 and a first end of the attenuator 53. Moreover, a first contact terminal T1, and a second contact terminal T2, of the DPDT switch 55 are connected respectively to a second end of the attenuator 53 and the detection circuit 34 (not shown).

In a state where a switching signal is not inputted from the control circuit 35 to the ATT switching circuit 36 with the above-described configuration, the first pole P1 and the second pole P2 are connected respectively to the second contact terminal T2 and the first contact terminal T1, in the DPDT switch 55.

As a result, a high-frequency transmission signal sent from the detection circuit 34 is sent to the antenna 13 after passing through the second contact terminal T2, and then the first pole P1, of the DPDT switch 55. When a high-frequency transmission signal sent from the detection circuit 34 is caused to pass through the ATT switching circuit 36 without being intentionally attenuated, attenuation in the ATT switching circuit 36 occurs only inside the DPDT switch 55, and is thus very minute. Accordingly, the high-frequency transmission signal sent from the detection circuit 34 is sent to the antenna 13 substantially as it is.

On the other hand, in a state where a switching signal is inputted to the ATT switching circuit 36 from the control circuit 35, the first pole P1 and the second pole P2 are connected respectively to the first contact terminal Ti and the second contact terminal T2, in the DPDT switch 55. As a result, a high-frequency transmission signal sent from the detection circuit 34 is sent to the antenna 13 sequentially through: the second contact terminal T2 and the second pole P2 in the DPDT switch 55; the attenuator 53; and then the first contact terminal T1 and the first pole P1 in the DPDT switch 55.

In this case, the amount of attenuation in the ATT switching circuit 36 depends largely on the attenuator 53, which has an amount of attenuation significantly larger than the amount of attenuation occurring in the DPDT switch 55. Accordingly, the high-frequency transmission signal sent from the detection circuit 34 is attenuated by a predetermined amount of attenuation (for example, by 10 db) to be sent to the antenna 13.

Using the ATT switching circuit 36 having the above-described circuit configuration shown in FIG. 5 provides the following effects. Specifically, it is possible to reduce loss in the case of causing a signal sent from the detection circuit 34 to pass through the ATT switching circuit 36 without being intentionally attenuated, in comparison with the ATT switching circuit 36 having the circuit configuration shown in FIG. 4. Moreover, since the number of components constituting the ATT switching circuit 36 can be reduced, it is possible to reduce the manufacturing cost, and also to reduce an area required for mounting the components on a substrate.

As described above, the antenna module according to the first embodiment of the present invention provides the following effect. Suppose a case where it is detected that the computer is set in the tablet mode, and concurrently in the portrait position. When the level of a detection signal obtained by detecting a high-frequency transmission signal generated in the RF module 42 is not less than a predetermined level, the high-frequency transmission signal is attenuated by a predetermined amount to a level at or below the maximum acceptable SAR level, and is then sent to the antenna 13. Accordingly, the computer incorporating this antenna module can continue to operate without stopping its communication function while being kept at or below the maximum acceptable SAR level.

Note that the level of a high-frequency transmission signal outputted from the RF modulator 42 is controlled in accordance with the level of a reception signal. Accordingly, the detection signal may be generated by detecting, in the detection circuit 34, a high-frequency reception signal sent from the antenna 13, instead of a high-frequency transmission signal.

### Embodiment 2

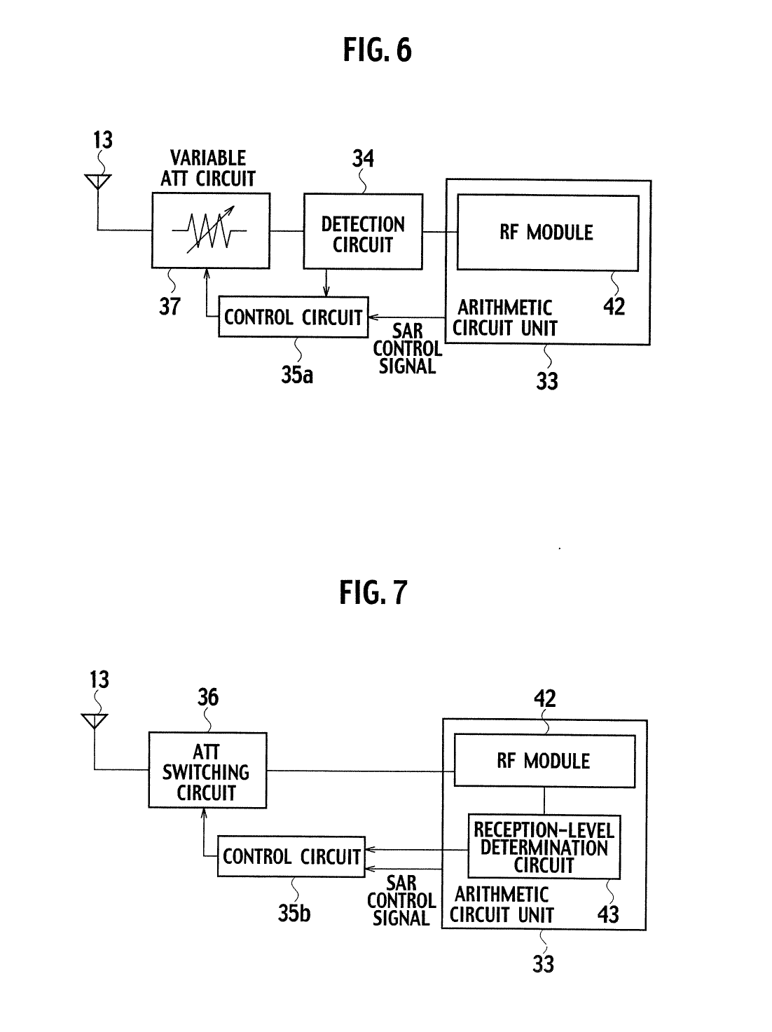

FIG. 6 is a circuit diagram showing, in an extracted manner, an antenna module part of a convertible type computer incorporating an antenna module according to Embodiment 2 of the present invention.

In this antenna module, the ATT switching circuit 36 in the antenna module according to Embodiment 1 shown in FIG. 3 is replaced with a variable ATT circuit 37, while the control circuit 35 is replaced with a control circuit 35a. Hereinafter, descriptions will be given mainly of points different from the antenna module according to Embodiment 1.

Suppose a case where a SAR control signal sent from the AND circuit 41 (see FIG. 2) of the arithmetic circuit unit 33 is active, that is, a case where the computer is set in the tablet mode as well as in the portrait position. In this case, based on the level of a detection signal outputted from the detection circuit 34, the control circuit 35a generates a control signal for attenuating a high-frequency transmission signal outputted from the detection circuit 34 to a level immediately below the maximum acceptable SAR level. The control circuit 35a then sends the generated control signal to the variable ATT circuit 37. The variable ATT circuit 37 attenuates the high-frequency transmission signal sent from the detection circuit 34 by an amount corresponding to the control signal sent from the control circuit 35a. The variable ATT circuit 37 then outputs the attenuated signal to the antenna 13.

In the antenna module according to Embodiment 2, the antenna 13 always radiates radio waves with the maximum intensity in a range not exceeding the maximum acceptable SAR level. For this reason, the computer incorporating this antenna module can continue to operate without stopping its communication function while being kept at or below the maximum acceptable SAR level.

### Embodiment 3

An antenna module according to Embodiment 3 of the present invention is characterized in that the intensity of a radio wave to be sent from the computer is varied in accordance with the distance between a base station and the computer. In general, when the distance from a local station to a base station is large, the reception level is low. Accordingly, the transmission level needs to be increased. In this case, since such an increased transmission level may relatively get closer to the maximum acceptable SAR level, it is necessary to perform an attenuation control.

On the other hand, when the distance from the local station to the base station is small, the reception level is high. Accordingly, the transmission level does not need to be increased. In this case, since the transmission level does not exceed the maximum acceptable SAR level, it is unnecessary to perform an attenuation control.

FIG. 7 is a circuit diagram showing, in an extracted manner, an antenna module part of a convertible type computer incorporating an antenna module according to Embodiment 3 of the present invention.

This antenna module is different from the antenna module according to Embodiment 1 shown in FIG. 3 in the following points. Specifically, the detection circuit 34 is removed. A reception-level determination circuit 43 is added inside the arithmetic circuit unit 33. Moreover, the control circuit 35 is replaced with a control circuit 35b. Hereinafter, descriptions will be given mainly of points different from the antenna module according to Embodiment 1.

The ATT switching circuit 36 sends a high-frequency reception signal sent from the antenna 13 to the RF module 42 of the arithmetic circuit unit 33. In addition, when a switching signal is not inputted to the ATT switching circuit 36 from the control circuit 35b, the ATT switching circuit 36 causes a high-frequency transmission signal sent from the RF module 42 to pass through the ATT switching circuit 36 without being intentionally attenuated. On the other hand, when a switching signal is inputted to the ATT switching circuit 36 from the control circuit 35b, the ATT switching circuit 36 attenuates a high-frequency transmission signal by a predetermined amount, and outputs the attenuated signal to the antenna 13.

The RF module 42 performs frequency conversion on a high-frequency reception signal sent from the ATT switching circuit 36, and then sends the resultant signal of the frequency conversion as a reception signal to the reception-level determination circuit 43. In addition, the RF module 42 generates a high-frequency transmission signal based on a transmission signal generated inside the arithmetic circuit unit 33. The RF module 42 then sends the generated high-frequency transmission signal to the ATT switching circuit 36.

The reception-level determination circuit 43 determines the level of the reception signal sent from the RF module 42, and then sends the result of the determination as a reception level signal to the control circuit 35b.

Suppose a case where a SAR control signal sent from the AND circuit 41 (see FIG. 2) of the arithmetic circuit unit 33 is active, that is, a case where the computer is set in the tablet mode as well as in the portrait position. In this case, when the reception level signal sent from the reception-level determination circuit 43 is not more than a predetermined level, a high-frequency transmission signal with a high level may possibly be sent from the RF module 42. Accordingly, the control circuit 35b recognizes that it is necessary to perform an attenuation control.

As in the case of the antenna module according to Embodiment 1, the control circuit 35b compares the level of the reception level signal, received from the reception-level determination circuit 43, with a predetermined level (a level with which a radio wave exceeds the maximum acceptable SAR level when the antenna 13 radiates the radio wave upon receipt of a corresponding high-frequency transmission signal sent from the detection circuit 34). When the level of the reception level signal is not more than the predetermined level, the control circuit 35b generates a switching signal, and then transmits the generated signal to the ATT switching circuit 36.

On the other hand, when the level of the reception level signal sent from the reception-level determination circuit 43 exceeds the predetermined level, a high-frequency transmission signal with a low level will be outputted from the RF module 42. Accordingly, the control circuit 35b recognizes that it is unnecessary to perform an attenuation control, and does not send a switching signal to the ATT switching circuit 36. As a result, a high-frequency transmission signal outputted from the RF module 42 is caused to pass through the ATT switching circuit 36 without being intentionally attenuated so as to be sent to the antenna 13.

In the antenna module according to Embodiment 3, when the computer is positioned close to the base station, the level of a high-frequency transmission signal outputted from the RF module 42 is low. For this reason, the high-frequency transmission signal does not exceed the maximum acceptable SAR level even without an attenuation control to be performed thereon.

Accordingly, even in a case where the computer is used in the tablet mode as well as in the portrait position, when the reception level signal exceeds the predetermined level, a high-frequency transmission signal is not attenuated. Only when the reception level signal is not more than the predetermined level, a high-frequency transmission signal is attenuated. As a result, the computer incorporating this antenna module can continue to operate without stopping its communication function while being kept at or below the maximum acceptable SAR level. Moreover, since the antenna module according to Embodiment 3 does not require the detection circuit 34, an antenna module can be easily formed at low costs.

The present invention may be applied to a device, such as a laptop personal computer and a PDA (Personal Digital Assistant), that performs radio communications, and concurrently that may possibly be used close to the body.

What is Claimed is:

1. A computer comprising:
a first housing unit which includes a display unit which displays a image and a tablet unit which is superposed to the display unit to transmit the image;
a second housing unit which includes an arithmetic circuit which generates a signal for controlling to display the image;
a hinge unit which causes the first housing unit to be connected to the second housing unit so that the first housing unit is closed by facing one main plane which the first housing unit forms to crop out the tablet unit and other main plane which the second housing unit forms, and is connected to the second housing unit so that the first housing unit is closed by facing other main plane which the first housing unit forms and the one main plane which the second housing unit forms;
a mode sensor which detects that the first housing unit is closed by facing the other main plane of the first housing unit and the one main plane of the second housing unit;
an antenna which converts a high-frequency transmission signal into a radio wave, and which then radiates the radio wave;
a RF module which generates the high-frequency transmission signal;
an inclination sensor which detects an inclination of the computer so as to detect that the antenna is set in a state where the antenna may come close to a user's body;
a control circuit which generates a switching signal when a level of the high-frequency transmission signal sent from the RF module is not less than a predetermined level, in a case where the mode sensor detects that the first housing unit is closed by facing the other main plane of the first housing unit and the one main plane of the second housing unit, and concurrently where the inclination sensor detects that the antenna is set in the state where the antenna may come close to the user's body; and
a switching circuit which outputs, to the antenna, the high-frequency transmission signal sent from the RF module, in a case where the switching signal is not inputted to the switching circuit from the control circuit, and which outputs, to the antenna, the high-frequency transmission signal sent from the RF module after relatively attenuating the high-frequency transmission signal in comparison with the high-frequency transmission signal in the case where the switching signal is not inputted, in a case where the switching signal is inputted to the switching circuit from the control circuit.

2. A computer comprising:
a first housing unit which includes a display unit which displays a image and a tablet unit which is superposed to the display unit to transmit the image;
a second housing unit which includes an arithmetic circuit which generates a signal for controlling to display the image;
a hinge unit which causes the first housing unit to be connected to the second housing unit so that the first housing unit is closed by facing one main plane which the first housing unit forms to crop out the tablet unit and other main plane which the second housing unit forms, and is connected to the second housing unit so that the first housing unit is closed by facing other main plane which the first housing unit forms and the one main plane which the second housing unit forms;
a mode sensor which detects that the first housing unit is closed by facing the other main plane of the first housing unit and the one main plane of the second housing unit;
an antenna which converts a high-frequency transmission signal into a radio wave, and which then radiates the radio wave;
a RF module which generates the high-frequency transmission signal;
an inclination sensor which detects an inclination of the computer so as to detect that the antenna is set in a state where the antenna may come close to a user's body;
a control circuit which generates a control signal for attenuating the high-frequency transmission signal sent from the RF module to a level immediately below a maximum acceptable level based on the high-frequency transmission signal sent from the RF module, in a case where the mode sensor detects that the first housing unit is closed by facing the other main plane of the first housing unit and the one main plane of the second housing unit, and concurrently where the inclination sensor detects that the antenna is set in the state where the antenna may come close to the user's body; and
an attenuation circuit which outputs, to the antenna, the high-frequency transmission signal sent from the RF module after attenuating the high-frequency transmission signal by an amount corresponding to the control signal sent from the control circuit.

3. A computer comprising:
a first housing unit which includes a display unit which displays a image and a tablet unit which is superposed to the display unit to transmit the image;
a second housing unit which includes an arithmetic circuit which generates a signal for controlling to display the image;
a hinge unit which causes the first housing unit to be connected to the second housing unit so that the first housing unit is closed by facing one main plane which the first housing unit forms to crop out the tablet unit and other main plane which the second housing unit forms, and is connected to the second housing unit so that the first housing unit is closed by facing other main plane which the first housing unit forms and the one main plane which the second housing unit forms;
a mode sensor which detects that the first housing unit is closed by facing the other main plane of the first housing unit and the one main plane of the second housing unit;
an antenna which generates a high-frequency reception signal upon reception of an incoming radio wave, and which also converts a high-frequency transmission signal into a radio wave so as to radiate the radio wave;
a RF module which generates the high-frequency transmission signal to be sent to the antenna, and which also generates a reception signal from the high-frequency transmission signal sent from the antenna;
a reception-level determination circuit which determines a level of the reception signal sent from the RF module;
an inclination sensor which detects an inclination of the computer so as to detect that the antenna is set in a state where the antenna may come close to a user's body;
a control circuit which generates a switching signal when the level of the reception signal is not more than a predetermined level, in a case where the mode sensor detects that the first housing unit is closed by facing the other main plane of the first housing unit and the one main plane of the second housing unit, and concurrently where the inclination sensor detects that the antenna is set in the state where the antenna may come close to the user's body; and
a switching circuit which outputs, to the antenna, the high-frequency transmission signal sent from the RF module, in a case where the switching signal is not inputted to the switching circuit from the control circuit, and which outputs, to the antenna, the high-frequency transmission signal sent from the RF module after relatively attenuating the high-frequency transmission signal in comparison with the high-frequency transmission signal in the case where the switching signal is not inputted, in a case where the switching signal is inputted to the switching circuit from the control circuit.

4. The computer according to claim 1 wherein
the switching circuit includes a DPDT (Double Pole/Double Throw) switch and an attenuator, and
a first pole, a second pole, a first contact, and a second contact, of the DPDT switch are connected respectively to the antenna, an end of the attenuator, another end of the attenuator, and the detection circuit.

5. The computer according to claim 3 wherein
the switching circuit includes a DPDT (Double Pole/Double Throw) switch and an attenuator, and
a first pole, a second pole, a first contact, and a second contact, of the DPDT switch are connected respectively to the antenna, an end of the attenuator, another end of the attenuator, and the detection circuit.

6. A switching circuit comprising:
an attenuator which attenuates a signal inputted thereto to output the attenuated signal;
a DPDT switch which has a first pole connected to a first input/output terminal, a second pole connected to an end of the attenuator, a first contact connected to another end of the attenuator, and a second contact connected to a second input/output terminal.
